(19) United States
(12) Patent Application Publication
(10) Pub. No.: US 2013/0129329 A1
(43) Pub. Date: May 23, 2013

(54) DEVICE FOR THERMALLY TREATING SUBSTRATES

(71) Applicants: Andreas Caspari, St. Wendel (DE); Stefan Henkel, Stockstadt (DE); Jutta Trube, Mombris (DE); Sven Stille, Munster (DE); Martin Fürfanger, Steinhoring (DE)

(72) Inventors: Andreas Caspari, St. Wendel (DE); Stefan Henkel, Stockstadt (DE); Jutta Trube, Mombris (DE); Sven Stille, Munster (DE); Martin Fürfanger, Steinhoring (DE)

(73) Assignees: SAINT-GOBAIN GLASS FRANCE, COURBEVOIE (FR); LEYBOLD OPTICS GMBH, ALZENAU (DE)

(21) Appl. No.: 13/579,212

(22) PCT Filed: Feb. 14, 2011
(86) PCT No.: PCT/EP2011/000680

§ 371 Date: Feb. 5, 2013

(30) Foreign Application Priority Data
Feb. 15, 2010 (DE) 10 2010 008 084.5

(51) Int. Cl. F27D 11/12

(52) U.S. Cl. CPC F27D 11/12
USPC 392/416

(57) ABSTRACT

The invention relates to a heat treatment inner chamber (3) for thermally processing a substrate (20), having walls (10) which enclose an inner space (24) of the heat treatment inner chamber (3), having a mounting apparatus (8) for mounting the substrate (20) during the thermal processing and having an energy source (11) for introducing energy into the inner space (24) of the heat treatment inner chamber (3), at least one part of the inner sides of the walls (10) being formed in order to reflect power introduced by the energy source (11), wherein the at least one part of the inner sides of the walls (10) consists of a material which is highly reflective at least for infrared radiation.

The invention furthermore relates to a heat treatment inner chamber (3) for thermally processing a substrate (20), having walls (10) which enclose an inner space (24) of the heat treatment inner chamber (3), having a mounting apparatus (8) for mounting the substrate (20) during the thermal processing and having an energy source (11) for introducing energy into the inner space (24) of the heat treatment inner chamber, wherein a cooling device (14) is provided for cooling the walls (10).

The invention relates to a heat treatment inner chamber for thermally processing a substrate, according to the precharacterizing clause of claim 1, as is described for example in U.S. Pat. No. 6,703,589 B1 which defines the generic type. The invention furthermore relates to a processing chamber having a heat treatment inner chamber which is arranged inside an outer chamber and is suitable for thermally processing a substrate, according to the precharacterizing clause of claim 18.

For the surface treatment of substrates, for example by coating using condensation of metal vapour in a high vacuum or by sputtering processes, process steps in which the substrate (and the coating possibly applied on the substrate) are subjected to thermal preprocessing and/or postprocessing are often necessary. To this end, the substrate is typically heated to the desired temperature with the aid of a heat source and kept at this temperature for a predetermined time.

DE 103 04 774 B3 discloses a method for heating workpieces, in which the workpiece is accommodated in a closed container and the substrate is heated by means of convection of a gas. The gas is fed over a heating body, and subsequently flows around the workpiece to be heated. The method allows very uniform transfer of heat to the workpiece, but requires the presence of a heating flow. Furthermore, in the case of large two-dimensional workpieces, rapid heating (>1° C./s) with a high surface power density (>10 W/cm²) can only be achieved with great difficulty.

EP 662 247 B1 describes a two-stage method for producing a thin-film solar cell, in the course of which a heat treatment is carried out. In order to produce a copper indium diselenide (CIS) semiconductor layer on a substrate, the constituent components of the semiconductor Cu, In and Se are first applied in elemental form onto the substrate which is provided with an Mo electrode; this layer structure is subsequently heated together to a process temperature of about 400° C., so that the CIS semiconductor layer is formed. The heat treatment of the layer structure is carried out so that a desired partial pressure of the constituent components is maintained during the heating process. In order to ensure this, the substrate with the layer structure is enclosed in a closed container, for example a graphite box, and heated in this container by using heating means, for example halogen lamps. The closed container ensures that none of the components can escape during the heating process, so that a chalcopyrite having the desired stoichiometric ratio of the components is produced on the substrate. Graphite has a high emissivity and a high thermal conductivity, and can therefore rapidly and efficiently absorb the radiation emitted by the halogen lamp and deliver it to the layer structure contained in the graphite box. As an alternative, it is proposed to heat the layer structure with the aid of optical means while enclosing it in a container made of a transparent material, for example quartz.

If the container described in EP 662 247 E1 is used for the heat treatment of large-surface multilayer bodies, then—particularly in the case of rapid heating—there is a risk of inhomogeneous heat input into the individual layers of the multilayer body, which can cause cracks or fractures of the layers. In order to avoid this problem, DE 199 36 081 A1 proposes to provide a plurality of energy sources for the heating, with the aid of which the individual layers of the multilayer body can be heated individually. To this end, a transparent body is arranged between the layer to be heated and its associated energy source, the transmission and absorption capacities of which are adapted to the layer in question. The heating body may for example consist of a glass ceramic, which absorbs and transmits a large part of the heat radiation. in this way, the mechanical stresses which occur during the heat treatment are intended to be minimized. In particular, the multilayer body may be arranged in a closed container whose walls facing towards the energy sources are formed by the transparent bodies.

U.S. Pat. No. 6,703,589 B1, which defines the generic type, describes a processing chamber for the heat treatment of workpieces in a toxic and/or corrosive gas atmosphere. The processing chamber comprises an outer chamber in which a closed heat treatment inner chamber is arranged, the workpiece to be heated being introduced into the latter. The processing chamber furthermore comprises heating means, with the aid of which the heat treatment inner chamber and the workpiece contained therein can be heated.

Various methods and devices for the heat treatment of substrates are therefore known from the aforementioned documents. The walls of the heat treatment inner chambers typically consist of a material which absorbs and transmits heat radiation (for example graphite or a glass ceramic). The result of this is that a large part of the power introduced into the heat treatment inner chamber heats the walls of this chamber, which can lead to overheating of these walls when the cycle times are short. Furthermore, a part of the power is radiated outwards by the walls of the heat treatment inner chamber. This is problematic in particular when the heat treatment inner chamber is surrounded by a further chamber, for example a vacuum chamber, since the latter will experience heating which can cause damage to the vacuum container and the sensitive components contained therein.

It is an object of the invention to provide a heat treatment inner chamber for thermally processing substrates, in particular with the use of selenium, which makes it possible to introduce a high thermal energy efficiently into a substrate in a very short time, without leading to overheating of the heat treatment inner chamber, in particular the chamber walls. It is also an object to provide a processing chamber which allows thermal processing of substrates in a protective gas atmosphere and/or in a vacuum.

The object is achieved by the features of the independent claims. The dependent claims relate to advantageous configurations.

Accordingly, the heat treatment inner chamber for thermally processing a substrate

having walls which enclose an inner space of the heat treatment inner chamber,
having a mounting apparatus for mounting the substrate during the thermal processing and
having an energy source for introducing energy into the inner space of the heat treatment inner chamber, at least one part of the inner sides of the walls being formed in order to reflect power introduced by the energy source,
is distinguished in that the at least one part of the inner sides of the walls consists of a material which is highly reflective at least for infrared radiation.

Making the inner sides of the walls from a material which reflects at least infrared radiation advantageously achieves simplified and more economical manufacture compared with the prior art.

In what follows, the term highly reflective refers to a material having a reflectance of >60%, preferably of >80%, particularly preferably of >90%. Such values of the reflectance are preferably provided in a wavelength range of between 250 nm and 3000 nm, particularly preferably between 600 nm and 2000 nm. The material is thermally stable up to 200° C., preferably up to 500° C., particularly preferably 900° C. The material is preferably inert with respect to the substances used for the heat treatment, for example selenium.

In another embodiment, the heat treatment inner chamber, in which the substrate is accommodated during the heat treatment, has a cooling device with which the wall of the heat treatment inner chamber can be cooled. With the aid of the cooling device, the heat treatment inner chamber, inside which high temperatures are generated during the heat treatment with the aid of an energy source, can be thermally shielded from the surroundings. The cooling device furthermore removes the heat energy introduced into the chamber walls, and thus prevents overheating of the heat treatment inner chamber.

The cooling device is preferably formed as a cooling circuit for a liquid or gaseous coolant with a high specific heat capacity, in particular an oil, which is circulated through the walls of the heat treatment inner chamber. To this end, the walls of the heat treatment inner chamber are provided at least in sections with cooling channels, through which the coolant is fed. Expediently all the walls of the heat treatment inner chamber are provided with cooling channels, so that the radiation of heat by the heat treatment inner chamber in the direction of the outer chamber can be limited or reduced on all sides. The cooling channels may extend in a meandering fashion in the walls of the heat treatment inner chamber; in this case, the cooling channels are preferably arranged in such a way that the cold coolant is introduced into a wall region which is heated most intensively during the heat treatment, from where it is fed on to less thermally stressed wall regions.

If very high temperatures (>500° C. and up to 2000° C. or more) are intended to be generated in the inner space of the heat treatment inner chamber, then the heat treatment inner chamber and the components contained therein are subjected to high thermal and corrosive stress; the materials selected for them must therefore have high thermal stability, and in particular be corrosion-resistant with respect to selenium. Suitable materials for the walls of the heat treatment inner chamber are in particular refractory steels, although these generally have a comparatively low thermal conductivity. Austenitic stainless steel AISI 316L is preferred. In order to ensure that the coolant circulating through the cooling channels in the walls of the heat treatment inner chamber can remove the heat efficiently and large temperature gradients are not formed, it is advantageous to configure the cooling channels with a rectangular cross section. Neighbouring cooling channels are separated by webs, the width of which is preferably between 20% and 80% of the width of the cooling channels. The effect achieved by the relatively small web width is that the heat power radiated in is brought to the coolant over a short path with a relatively large cross section, while sufficiently high mechanical stability can simultaneously be achieved. The height of the webs is set in order to drive enough coolant through the cooling channels so that the temperature difference in the coolant is kept sufficiently small. The height of the webs is preferably between 20% and 80% of the width of the cooling channels.

The energy for heating the substrate in the heat treatment inner chamber is preferably supplied with the aid of a heating means which emits electromagnetic radiation in the infrared range and is arranged in the heat treatment inner chamber. The heating means may for example be formed by one or more heatable quartz rods, which protrude into the heat treatment inner chamber. A multiplicity of quartz rods are preferably provided, these being arranged mutually parallel and parallel to the substrate surface. In order to achieve uniform heating of the lower and upper sides of the substrate, quartz rods may be arranged both above and below the substrate surface. As an alternative, the heating energy may for example be generated by laser radiation in the infrared, visible or ultraviolet spectral range, which is introduced into the heat treatment inner chamber through suitable windows.

Expediently, the heat treatment inner chamber is a closable container so that the inner space of the heat treatment inner chamber is fully enclosed by the walls during the thermal processing of the substrate, and the heating means radiates its thermal energy only into the heat treatment inner chamber but not into regions lying outside the heat treatment inner chamber. Feed-throughs (cables etc.) for the energy supply of the heating means may be thermally insulated, in order to minimize local inhomogeneities in the energy flux out of the heat treatment inner chamber.

In order to achieve heating of the inner space of the heat treatment inner chamber which is as rapid and effective as possible, and in order to minimize the proportion of heating power transmitted into the chamber walls, reflectors may be arranged in the inner space of the heat treatment inner chamber.

Preferably, at least the heat treatment inner chamber's wall surfaces facing towards the inner region preferably consist of a material having a high reflectance in the wavelength range of from visible light to the far infrared at 2000 nm or 3000 nm. If the energy is supplied with the aid of infrared radiators (for example quartz rods), then high reflection is preferably provided at least in the wavelength range of the infrared radiator. For example, stainless steel, molybdenum, gold, nitrides such as titanium nitride or silicon nitride, or a diffusely highly reflective thermoplastic (for example pressed PTFE with an effective spectral range of from 250 nm to 2500 nm and a reflectance of 99% between 400 nm and 1500 nm and more than 95% between 250 nm and 2500 nm, with thermal stability up to a temperature of 400%, known as Spectralon from Labsphere) may be used as surface material or wall material.

The inner walls of the heat treatment inner chamber are advantageously provided with reflectors which shield these walls against the thermal power delivered into the inner space.

It is advantageous to provide intermediate reflector walls made of a material which is highly reflective at least for IR radiation, or having intermediate reflector wall surfaces consisting of such a material and facing towards the inner region, which are arranged in front of and preferably with their rear side separated from the heat treatment inner chamber's wall surfaces facing towards the inner region. If intermediate reflector walls are used, the heat treatment inner chamber's walls arranged behind them may have a lower reflectance, for example between 40% and 60%.

Further reflectors may be formed, and arranged in the heat treatment inner chamber, in such a way that they focus the electromagnetic radiation heating the substrate (for example infrared radiation) onto the substrate. Furthermore, (additional) mobile (for example tiltable) reflector plates may be provided, which locally influence the power radiated into the substrate. With the aid of such reflector plates, it is in particular possible to achieve homogenization of the temperature profile in the edge region of the substrate.

In order preferably to achieve further homogenization of the energy radiated onto the substrate, semitransparent intermediate reflectors (for example made of glass ceramic) may be arranged between the substrate and the cooled walls of the heat treatment inner chamber.

For introducing the substrate into the heat treatment inner chamber and removing it therefrom, it is expedient to provide closable openings whose cross section is adapted to the substrate shape; in systems for processing flat substrates, the openings are formed in the shape of slits. A conveyor apparatus for holding and transporting the substrate in the heat treatment inner chamber may furthermore be provided in the inner space of the heat treatment inner chamber. Expediently, the mounting apparatus, on which the substrate is mounted during the thermal processing in the heat treatment inner chamber, is formed as a conveyor apparatus.

If the heat treatment constitutes an intermediate step between two other processing steps, which require a vacuum or the use of different process gases, then it is often advantageous in terms of process technology to carry out the heat treatment inside a vacuum container, so that no additional outlay is incurred for evacuation before or after the heat treatment. A processing chamber suitable for such a process comprises a heat treatment inner chamber having cooled walls, which is arranged inside an outer chamber, in particular a vacuum chamber. Owing to the cooled walls, the hot inner space of the heat treatment inner chamber is thermally isolated from the vacuum chamber. This ensures that the components of the vacuum chamber, which are in general highly temperature-sensitive, do not suffer any damage even when carrying out high-temperature heat treatments (in particular at >500° C.)

The heat treatment inner chamber arranged inside the outer chamber is supported on the walls of the outer chamber with the aid of spacers, which consist of a material having a low thermal conductivity. If a coolant circuit is used for cooling the heat treatment inner chamber—as described above—then it is expedient to use conduits, which extend inside the spacers, for supplying the coolant into the walls of the heat treatment inner chamber and for discharging it therefrom.

The inventive structure of the processing chamber allows efficient heat treatment of substrates, in which high energy input can be introduced into the substrate within a short time without leading to overheating of the outer chamber (vacuum chamber) enclosing the heat chamber. Even when large surface power densities of >15 w/cm² are radiated onto the substrate, the inner space of the heat treatment inner chamber is thermally shielded effectively from the outer chamber.

The invention will be explained in more detail below with the aid of an exemplary embodiment represented in the figures, in which:

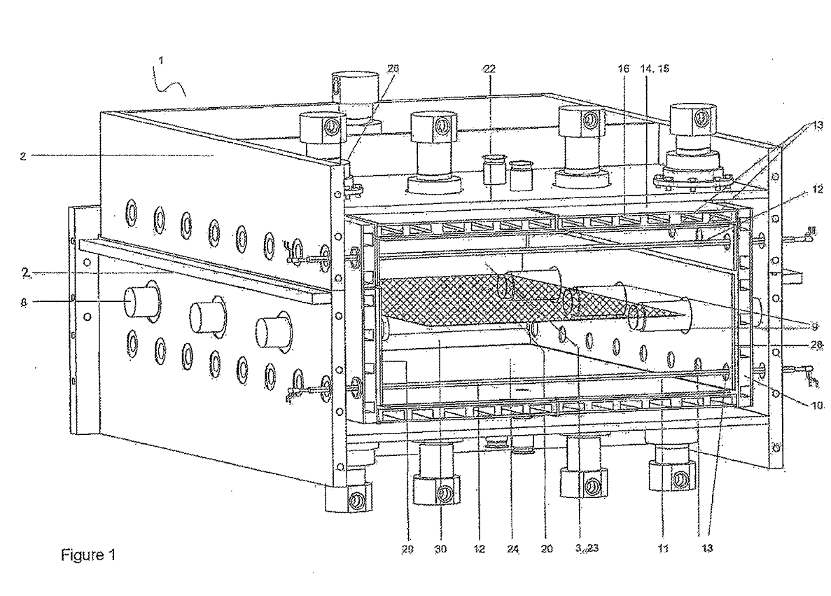

FIG. 1 shows a processing chamber having an outer chamber and a heat treatment inner chamber for the thermal processing of a substrate, in a perspective sectional representation in the transverse direction;

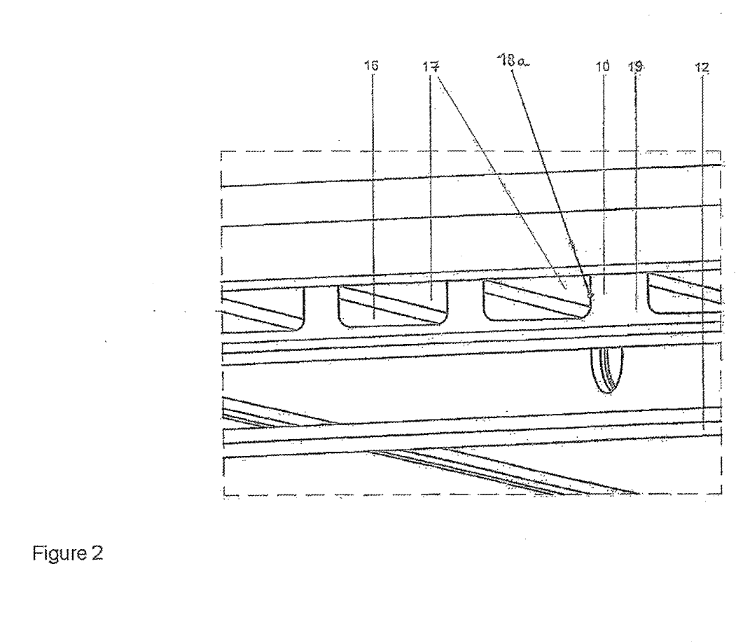

FIG. 2 shows a detail view of the wall of the heat treatment inner chamber according to an excerpt of FIG. 1.

In the drawings, elements which correspond to one another are denoted by the same references. The drawings represent a schematic exemplary embodiment and do not reflect specific parameters of the invention. Furthermore, the drawings merely serve to explain an advantageous embodiment of the invention and should not be interpreted in such a way that they narrow the protective scope of the invention.

FIGS. 1 and 2 show perspective sectional representations of a processing chamber 1 for the thermal treatment of substrates 20. Here, the term “substrate” is intended to mean any object to be processed, to be coated and/or already coated, i.e. both an (optionally pretreated) carrier material per se and a carrier material with single or multiple coatings. In the exemplary embodiment of FIGS. 1 and 2, the substrates are two-dimensional workpieces, the area of which may lie between a few square centimetres and a few square metres.

The substrate 20 may also be placed in a substrate box, which is preferably semitransparent for heat radiation, preferably having walls made of glass ceramic and a graphite frame for supporting the walls.

The term “thermal processing” is intended to mean any process or process step which involves heating the substrate.

The processing chamber 1 comprises an evacuable vacuum chamber (outer chamber) 2, in the inner space 22 of which a heat treatment inner chamber 3 is arranged. The heat treatment inner chamber 3 is configured as a closable container 23 having walls 10, which enclose the inner space 24 of the heat treatment inner chamber 3 preferably on all sides. The heat treatment inner chamber 3 does not, however, have to be closable in a gastight fashion; rather, the inner space 24 of the heat treatment inner chamber 3 may be flushed or evacuated, for example with the aid of the outer chamber 2. The inner sides of the walls 10 preferably consist of a metallic material which is highly reflective at least for infrared radiation. It is furthermore preferable for the walls 10, in particular the inner sides of the walls, to consist of a material having a high thermal stability, and in particular for them to be corrosion-resistant with respect to selenium, In particular, refractory steels, for example austenitic stainless steel AISI 316L, are suitable as a material for the walls 10 of the heat treatment inner chamber 3.

The processing chamber 1 is used for the thermal processing of substrates 20 in the course of a multistage production process. Correspondingly, the outer chamber 2 has entry and exit ports 4, through which the substrates 20 can be introduced from an upstream process stage (not shown in the figures) into the processing chamber 1 and transported on from the processing chamber 1 into a further downstream process stage (not shown in the figures). In order to introduce the substrates 20 into the heat treatment inner chamber 3 and remove them therefrom, closable slit-shaped openings (not represented) are provided on two mutually opposite end sides of the heat treatment inner chamber 3. In order to mount and transport the substrates 20, the heat treatment inner chamber 3 is provided with rollers 8 which can be rotated in a controlled or regulated fashion and are mounted in circular openings 9 in the wall 10 of the heat treatment. inner chamber 3.

In order to heat the substrate 20, the heat treatment inner chamber 3 has an energy source 11 having heating means 11′, which in the exemplary embodiment of FIGS. 1 and 2 are formed by heatable quartz rods 12 that are fed through recesses 13 in the wall 10 of the heat treatment inner chamber 3 into the inner space 24. For the sake of clarity, only a single quartz rod 12 is respectively represented in FIGS. 1 and 2; the multiplicity of recesses 13 shown in the wall 10 above and below the substrate plane, however, indicate that a multiplicity of quartz rods 12 aligned parallel to the substrate plane are provided, with the aid of which the substrate 20 can be heated from below and above. As an alternative or in addition, the thermal energy may for example be introduced into the heat treatment inner chamber 3 as (pulsed) electromagnetic radiation through windows.

In order to minimize the thermal stress of the outer chamber 2, the heat treatment inner chamber 3 is provided with a cooling device 14 by which the amount of heat delivered to the chamber walls 10 by the energy source 11 can (at least in a large part) be removed. The cooling device 14 therefore thermally shields the hot inner space of the heat treatment inner chamber 3 from the outer chamber 2. The cooling device 14 comprises a cooling circuit 15 for a liquid coolant (for example an oil) which circulates through cooling channels 16 in the walls 10 of the heat treatment inner chamber 3. The cooling device 14 furthermore comprises a pump (not represented in the figures) as well as a heat exchanger, by which the heated coolant flowing back out of the cooling channels 16 can be cooled before it is fed back to the cooling channels 16 of the heat treatment inner chamber 3.

The cooling channels 16 extend inside the wall 10 in a meandering fashion. In order to be able to withstand temperatures of >500° C., the walls 10 of the heat treatment inner chamber are made of a refractory steel. Such a steel has a low thermal conductivity, for which reason special measures need to be taken in order to achieve a homogeneous heat profile of the walls: the cooling channels 16 have an approximately rectangular cross-sectional profile. Neighbouring cooling channels 16 are separated by webs 18, the width 19 of which is less than the width 17 of the cooling channels 16; the web widths 19 are typically between 20% and 80% of the channel widths 17. The small web width 19 effectively prevents local heating of the walls in the web regions 18 lying between the cooling channels 16. Furthermore, the web heights 18a are selected in a range of between 20% and 80% of the channel widths 17.

The walls 10 of the heat treatment inner chamber 3 are fastened to the outer chamber 2 with the aid of spacers 26, preferably in such a way that each wall 10 is fastened to the outer chamber 2 by means of at least one spacer 26. Preferably, at least one of the walls 10 comprises individual fastening by only one spacer 26. The spacers 26 consist of a. material having a low thermal conductivity and are internally hollow; in the inner region of the spacers, feeds and discharges (not shown in the figures) are provided for supplying the cooling channels 16 with for cooling fluid.

In order to achieve heating of the inner space 24 of the heat treatment inner chamber 3 which is as rapid and effective as possible, and in order to minimize the proportion of heating power transmitted into the chamber walls 10, intermediate reflector walls 28 are arranged in the inner space 24 of the heat treatment inner chamber 3 and are preferably separated from the walls 10.

In the exemplary embodiment of FIGS. 1 and 2, the inner sides 29 of the walls 10 are coated with a material which has a high reflection capacity (reflectance) in the wavelength range of the heating means 11′ (here: in the infrared range in which the quartz rods 12 radiate) and therefore likewise acts as a reflector. The coating consists for example of Spectralon, a diffusely highly reflective thermoplastic. In addition—as indicated by way of example in FIG. 1—further reflectors 30 may be provided in selected regions of the inner space 24, for example in the corners, which lead to shielding of these regions from the radiation of the heating means 11′ and/or focusing of the heating infrared radiation onto the substrate 20. Between the walls 10 of the heat treatment inner chamber 3 and the substrate 20, it is also possible to provide a semitransparent intermediate reflector (for example made of quartz ceramic) which has a high thermal stability and leads to spatial homogenization of the heating.

In the exemplary embodiment of FIGS. 1 and 2, the heat is transferred from the heating means 11 (quartz rods 12) onto the substrate 20 predominantly by heat radiation. As an alternative, a protective gas, in particular an inert gas, may be introduced into the heat treatment inner chamber 3 through feeds and discharges (not shown in the figure) in order to achieve increased heat transfer with the aid of convection.

Means (not shown in the figures) for temperature measurement may be provided in the heat treatment inner chamber 3, for example pyrometers which are directed towards the substrate 20 and detect the heat radiation emitted by the substrate 20. Furthermore, the amount of energy removed from the walls 10 by means of the coolant may be determined by temperature measurements in the supply and return paths of the coolant circuit 15, and compared with the energy radiated in; this allows continuous monitoring of the heat budget of the heat treatment inner chamber 3, in order to detect or Prevent overheating.

The device is suitable in particular for the production of thin-film solar cells or thin-film solar modules having a carrier layer made of a glass or quartz, onto which an Mo layer as an electrode and a functional layer of a copper indium diselenide (CIS) semiconductor or a copper indium gallium sulfo-selenide (CIGSSe) semiconductor are applied.

### LIST OF REFERENCES

1 processing chamber
2 outer chamber (vacuum chamber)
3 heat treatment chamber
8 roller
9 opening in wall of the heat treatment chamber
10 wall of the heat treatment chamber
11 energy source
12 heatable quartz rod
13 recess in wall (for quartz rod)
14 cooling device
15 cooling circuit
16 cooling channel
17 width of cooling channel
18 web
18a web height
19 width of web
20 substrate
22 inner space of the outer chamber
23 container=heat treatment chamber
24 inner space of the heat treatment chamber
26 spacer
28 intermediate reflector
29 inner side of wall
30 edge region reflector

1-17. (canceled)

18. A heat treatment inner chamber for thermally processing a substrate using selenium, comprising:
walls which enclose an inner space of the heat treatment inner chamber, a mounting apparatus for mounting the substrate during the thermal processing, and an energy source for introducing energy into the inner space of the heat treatment inner
chamber,
wherein at least one wall or one part of inner sides of the walls of the heat treatment inner chamber being formed in order to reflect power introduced by the energy source, and
wherein at least one part of the wall or of the inner sides of the walls comprises refractory, selenium-proof nitrides, titanium nitride, silicon nitride, which are highly reflective at least for infrared radiation, or diffusely highly reflective thermoplastic, or comprises such materials.

19. The heat treatment inner chamber according to claim 18, further comprising at least one partially transparent intermediate reflector wall and/or one edge reflector arranged between the wall of the heat treatment inner chamber and the substrate for temperature homogenization.

20. The heat treatment inner chamber according to claim 18, further comprising a cooling device for cooling at least one part of the walls, the cooling device comprises a circuit for a liquid coolant and at least one wall of the heat treatment inner chamber is provided with cooling channels, wherein the cooling channels have an approximately rectangular cross section, extend in a meandering fashion in the wall of the heat treatment inner chamber and neighboring cooling channels are separated by webs, the width and height of which is between 20% and 80% of the width of the cooling channels.

21. The heat treatment inner chamber according to claim 18, wherein the walls enclose the inner space of the heat treatment inner chamber on all sides.

22. The heat treatment inner chamber according to claim 21, wherein at least 80% of the wall surface and/or all the walls of the heat treatment inner chamber are provided with cooling channels.

23. The heat treatment inner chamber according to claim 18, wherein the energy source comprises a heating means for emitting thermal energy, which is arranged in the heat treatment inner chamber.

24. The heat treatment inner chamber according to claim 23, wherein the heating means is formed by a multiplicity of quartz rods preferably extending parallel to the substrate surface.

25. The heat treatment inner chamber according to claim 24, wherein the quartz rods are arranged on both sides of the substrate surface.

26. The heat treatment inner chamber according to claim 20, wherein an intermediate reflector wall and/or an edge reflector for reflecting the power radiated in by the energy source is provided in the heat treatment inner chamber.

27. The heat treatment inner chamber according to claim 20, wherein at least one wall and/or at least the inner sides of the heat treatment inner chamber consist at least in sections of nitrides, titanium nitride, silicon nitride, which are highly reflective at least for infrared radiation, or diffusely highly reflective thermoplastic, or comprise such materials.

28. The heat treatment inner chamber according to claim 27, wherein the intermediate reflector wall and/or the edge reflector is shaped in such a way that it focuses the power radiated by the energy source onto the substrate.

29. The heat treatment inner chamber according to claim 20 wherein at least one partially transparent intermediate reflector for temperature homogenization is arranged between the cooled wall of the heat treatment inner chamber and the substrate.

30. The heat treatment inner chamber according to claim 18 wherein the heat treatment inner chamber comprises closable openings for introducing and removing the substrate.

31. The heat treatment inner chamber according to claim 18 wherein the heat treatment inner chamber is connected to a conveyor apparatus for transporting the substrate and/or in that the substrate is placed in a substrate box.

32. A processing chamber for thermally processing a substrate using selenium, comprising:
an outer chamber for shielding the substrate from the surroundings,
a heat treatment inner chamber arranged in the outer chamber for accommodating the substrate during the heat treatment, and
an energy source for introducing energy into an inner space of the heat treatment inner
chamber,
wherein the processing chamber comprises a cooling device for cooling at least one part of the walls of the heat treatment inner chamber,
wherein the cooling device comprises a circuit for a liquid coolant, and at least one wall of the heat treatment inner chamber is provided with cooling channels and the cooling channels have an approximately rectangular cross section, extend in a meandering fashion in the wall of the heat treatment inner chamber, neighboring cooling channels are separated by webs, the width and height of which are between 20% and 80% of the width of the cooling channels and/or in that at least one part of the wall or of the inner sides of the walls of the heat treatment inner chamber comprises refractory, selenium-proof nitrides, titanium nitride, silicon nitride, which are highly reflective at least for infrared radiation, or diffusely highly reflective thermoplastic.

33. A processing chamber according to claim 32, wherein the heat treatment inner chamber is fastened to the outer chamber with the aid of spacers.

34. A processing chamber according to claim 32, wherein the outer chamber is a vacuum chamber.
